(19) United States
(12) Patent Application Publication
(10) Pub. No.: US 2014/0329509 A1
(43) Pub. Date: Nov. 6, 2014

(54) METHOD FOR CONTROLLING STATUS INFORMATION AND AN ELECTRONIC DEVICE THEREOF

(71) Applicant: Samsung Electronics Co., Ltd., Suwon-si (KR)

(72) Inventors: Soo-Ji HWANG, Suwon-si (KR); Geon-Soo KIM, Suwon-si (KR); Han-Jib KIM, Suwon-si (KR); Byoung-Tack ROH, Suwon-si (KR); Jeong-Hyun PANG, Seongnam-si (KR); Yu-Jin LEE, Suwon-si (KR); Yong-Joon JEON, Hwaseong-si (KR); Eui-Chang JUNG, Seoul (KR)

(73) Assignee: Samsung Electronics Co., Ltd., Suwon-si (KR)

(21) Appl. No.: 14/266,205

(22) Filed: Apr. 30, 2014

(30) Foreign Application Priority Data
May 3, 2013 (KR) 10-2013-0049960

(51) Int. Cl. H04W 4/20

(52) U.S. Cl. CPC H04W 4/20
USPC 455/414.1

(57) ABSTRACT

An apparatus and a method for controlling status information in an electronic device are provided. The method for controlling the status information in the electronic device includes checking status information of other electronic device using a signal received from the other electronic device, determining control information corresponding to the status information, and displaying the control information.

### CROSS-REFERENCE TO RELATED APPLICATION(S)

This application claims the benefit under 35 U.S.C. §119(a) of a Korean patent application filed on May 3, 2013 in the Korean Intellectual Property Office and assigned Serial No. 10-2013-0049960, the entire disclosure of which is hereby incorporated by reference.

### TECHNICAL FIELD

The present disclosure relates to an apparatus and a method for controlling information corresponding to status information of counter electronic device in an electronic device.

### BACKGROUND

An electronic device, which has become a necessity in the modern life owing to its portability, is advancing to a multimedia device for providing various services such as voice and video telephony function, information input/output function, and data transmission/reception.

Currently, the electronic device can check status of a vehicle using an On Board Diagnosis (OBD) connector mounted to the vehicle. For example, by means of the OBD connector of the vehicle, the electronic device can check at least one of a speed, an engine Rotations Per Minute (RPM), a coolant temperature, an air intake temperature, an air intake amount, an engine oil temperature, a transmission oil, a Throttle Position Sensor (TPS), an Idle Speed Actuator (ISA), an oxygen sensor, an ignition angle, a fuel injection amount, and an air-fuel ratio. When a problem occurs in the vehicle, the electronic device can obtain the vehicle problem information from the OBD connector.

In addition, the electronic device may check the status of a house using a home automation system. For example, using the home automation system, the electronic device can check at least one of intrusion, gas leak, and fire in the house.

As discussed above, the electronic device can check the status information of the other electronic device using a signal received from the other electronic device (e.g., vehicle and home automation system). In this regard, the electronic device needs a service corresponding to the status information of the other electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address the above-mentioned problems and/or disadvantages and to provide at least the advantages described below. Accordingly, an aspect of the present disclosure is to provide an apparatus and a method for checking status information of the other electronic device in a signal received from the other electronic device, in an electronic device.

Another aspect of the present disclosure is to provide an apparatus and a method for generating control information corresponding to status information of the other electronic device, in an electronic device.

Yet another aspect of the present disclosure is to provide an apparatus and a method for displaying control information corresponding to status information of the other electronic device, in an electronic device.

In accordance with an aspect of the present disclosure, a method for controlling status information in an electronic device is provided. The method includes checking status information of other electronic device using a signal received from the other electronic device, determining control information corresponding to the status information, and displaying the control information.

In accordance with another aspect of the present disclosure, an electronic device is provided. The electronic device includes a display, at least one processor, at least one memory, and at least one program stored in a memory and configured for execution by the at least one processor. The processor checks status information of other electronic device using a signal received from the other electronic device, determines control information corresponding to the status information, and displays the control information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a detailed block diagram of a processor according to an embodiment of the present disclosure;

FIG. 3 is a flowchart of a method for generating control information corresponding to status information of the other electronic device, in the electronic device according to an embodiment of the present disclosure; and

FIGS. 4A, 4B, 4C, 4D and 4E are diagrams of a screen for displaying the control information corresponding to the status information of the other electronic device, in the electronic device according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Various embodiments of the present disclosure provide a technique for providing control information corresponding to status information of the other electronic device to an electronic device.

Hereinafter, an electronic device can encompass a mobile communication terminal, a Personal Digital Assistant (PDA), a Personal Computer (PC), a laptop, a smart phone, a netbook, a television, a Mobile Internet Device (MID), an Ultra Mobile PC (UMPC), a tablet PC, a navigation device, a smart TV, and an MP3 player.

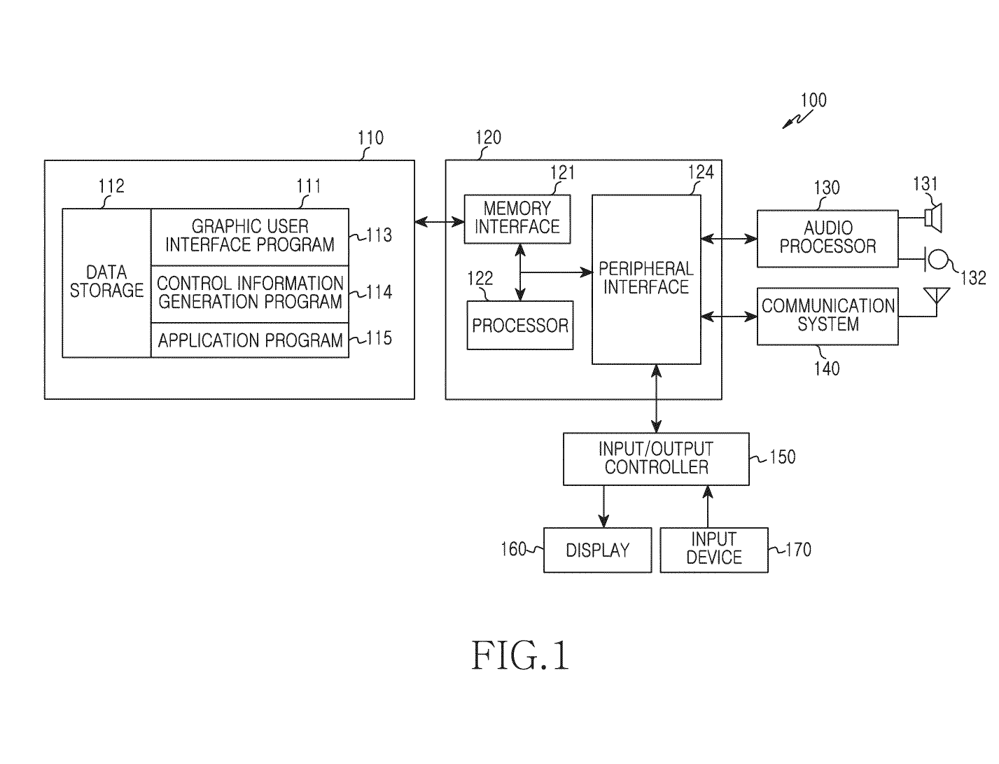

FIG. 1 is a block diagram of an electronic device according to an embodiment of the present disclosure.

Referring to FIG. 1, the electronic device 100 can include a memory 110, a processor unit 120, an audio processor 130, a communication system 140, an input/output controller 150, a display 160, and an input device 170. Herein, a plurality of the memories 110 may be equipped.

Those components are described now.

The memory 110 can include a program storage 111 for storing a program to control operations of the electronic device 100, and a data storage 112 for storing data generating in the program execution. For example, the data storage 112 stores databases for identifying status information of the other electronic device provided through the communication system 140 (Table 1). For example, the data storage 112 stores the databases relating to schedule information, phone number, map information, communication list, status guide message, and application program driving information, which are required for a control information generation program 114 to generate control information. Wherein the communication list is comprising at least one of a call list and message list. It is assumed that the phone number belongs to at least one category of a public institution, a hospital, an insurance company, a garage, a gas station, and a user contact, and each category has a unique ID (Table 2). In addition, the memory 110 may combine and store the databases.

TABLE 1

| | Status | |
|---|---|---|
| STATUS_ID | Information | Status Guide Message |
| 0 | Fender-bender | Accident occurred. Please calm down |
| | | and make a call. |
| 1 | Discharge | Battery is discharged. Please calm down |
| | | and make a call. |
| 2 | Maintenance | Overheated engine can cause an |
| | required | accident so we stop the car. Please |
| | | calm down and make a call. |
| 3 | Refuel required | Car runs out of gas so stops driving. |
| | | Please calm down and make a call. |

TABLE 2

| PROPERTY_ID | Category Contents |
|---|---|
| 0 | Public Institution |
| 1 | Hospital |
| 2 | Insurance Company |
| 3 | Garage |
| 4 | Gas Station |
| 5 | User Contacts |

The program storage 111 can include a Graphic User Interface (GUI) program 113, the control information generation program 114, and at least one application program 115. Herein, the program contained in the program storage 111 may be referred as an instruction set which is a set of instructions.

The GUI program 113 can include at least one software component for providing a graphical user interface on the display 160. For example, the GUI program 113 can control to display the control information generated by the control information generation program 114 in a topmost layer of at least one layer displayed by the display 160.

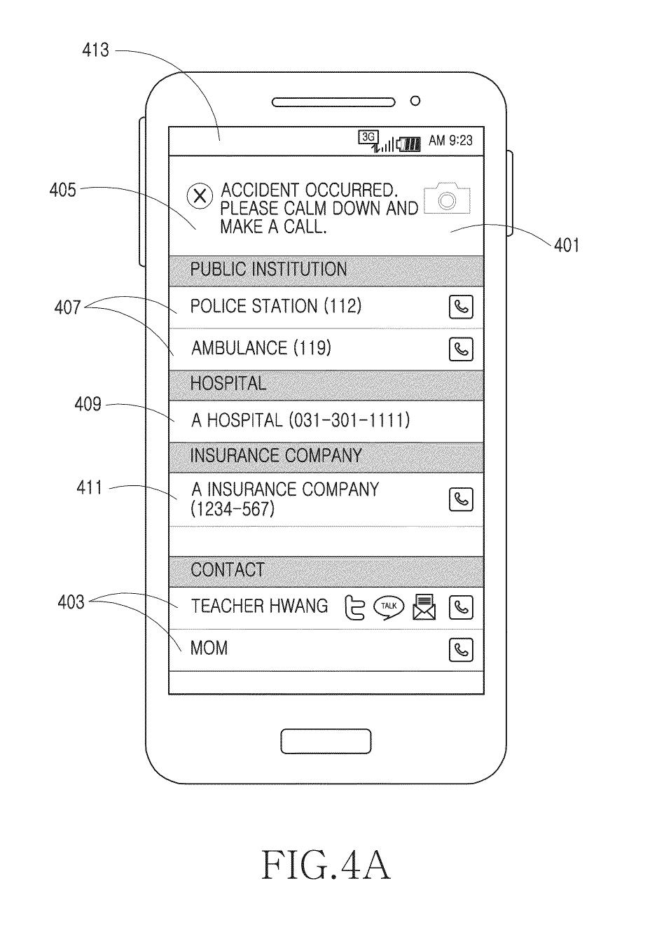

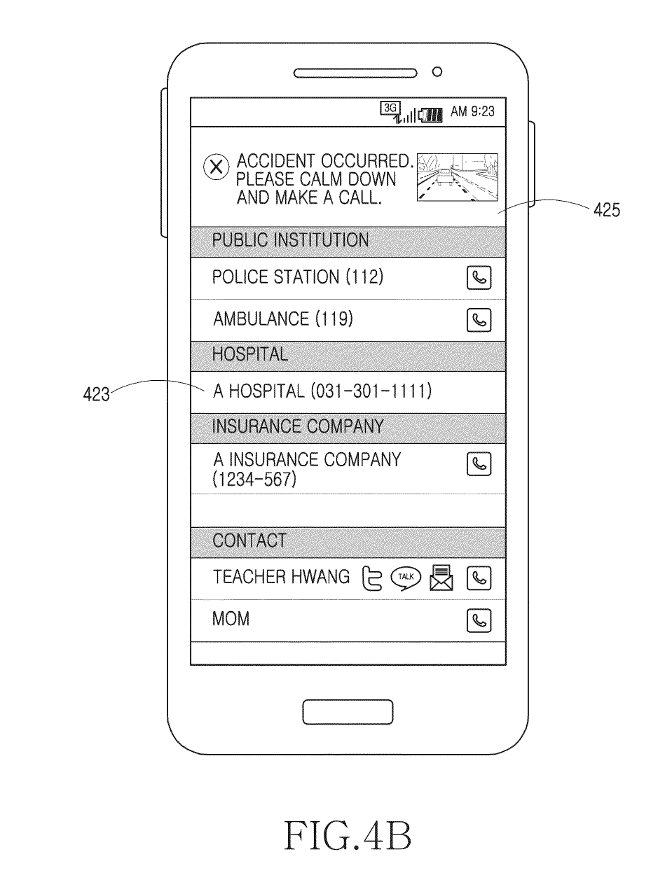

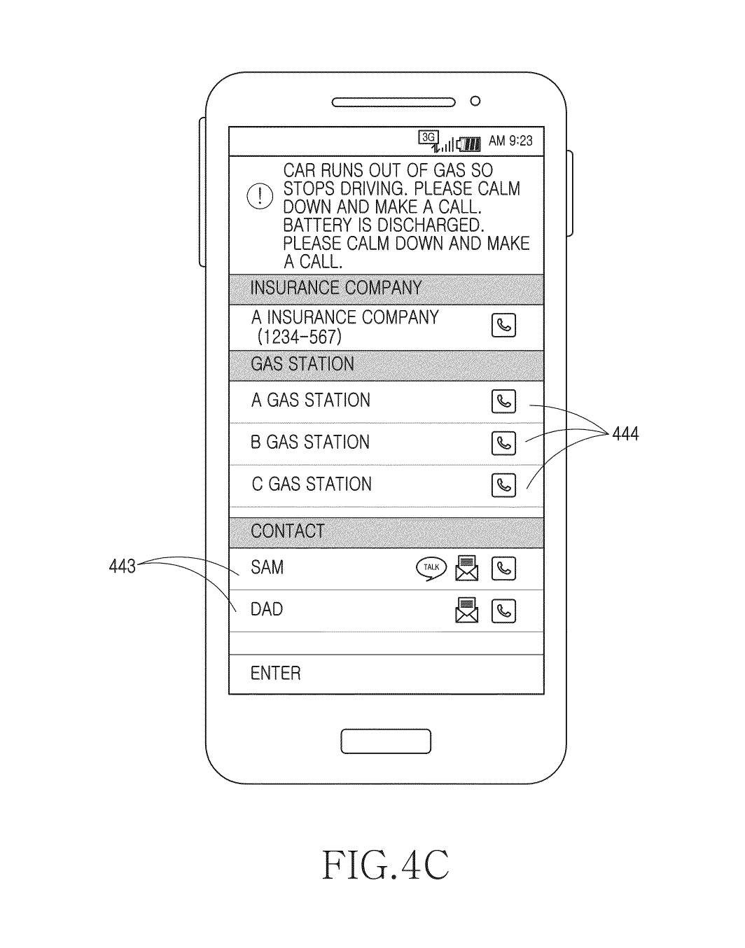

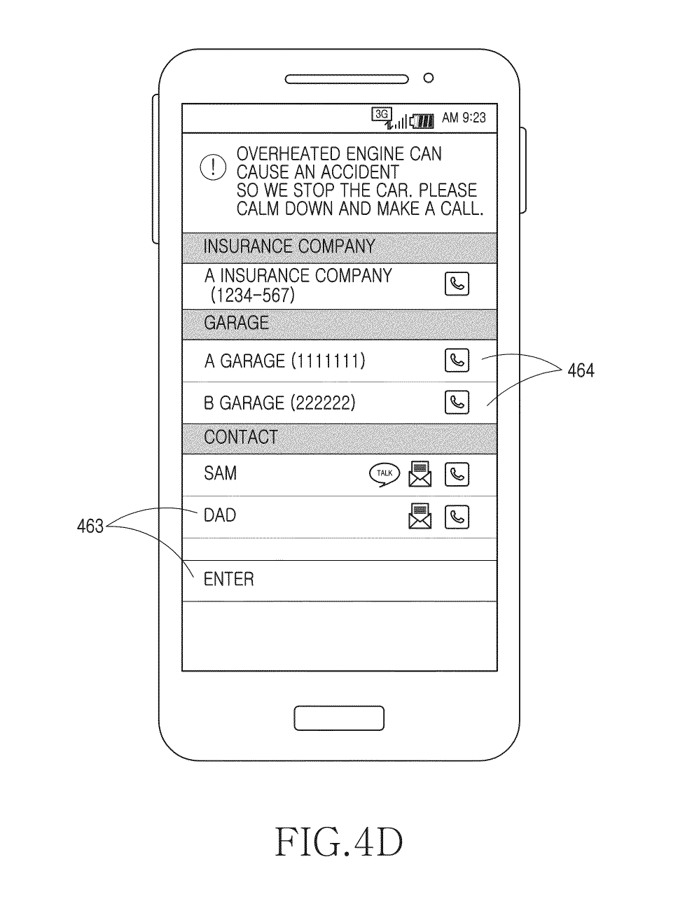

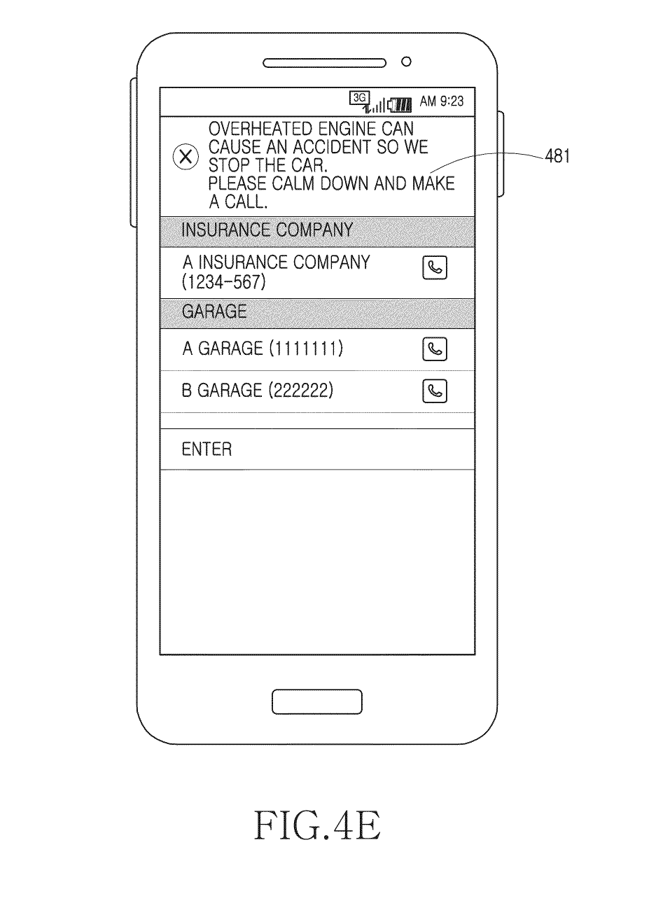

The control information generation program 114 can include at least one software component for generating the control information corresponding to the status information of the other electronic device using the signal received from the other electronic device. Herein, the control information can include at least one of contact information, an application program, and a status guide message. The control information can include at least one of data stored in the electronic device and data provided from a server. For example, when the signal received from an On Board Diagnosis (OBD) connector indicates the vehicle was in an accident, the control information generation program 114 determines the control information comprising at least one phone number 403 of the calls of the communication list within a predetermined time from the accident signal reception point as shown in FIG. 4A. In so doing, the control information generation program 114 may determine the control information comprising at least one phone numbers 403 by considering the call time order based on the accident signal reception point. The control information generation program 114 may determine the control information comprising at least one phone number of the calls of the communication list over a predetermined count within the predetermined time from the accident signal reception point. The control information generation program 114 additionally determines the control information further includes at least one insurance company phone number 411, at least one hospital phone number 409, at least one public institution phone number 407 and instructs the user to that an “Accident occurred. Please calm down and make a call” 405. The control information generation program 114 also determines the state 413 of the electronic device 100.

For example, when the signal received from the OBD connector indicates a vehicle accident, the control information generation program 114 may determine the control information comprising at least one hospital phone number 423 which is closest, based on location information of the electronic device as shown in FIG. 4B. For example, when the signal received from the OBD connector indicates a vehicle accident, the control information generation program 114 may launch a camera application and display a preview 425. Thus, the camera application may capture images, when the accident is occurred.

For example, when the signal received from the OBD connector indicates the vehicle accident, the control information generation program 114 may determine the control information comprising a shortcut of a camera application 401 as shown in FIG. 4A.

For example, when the signal received from the OBD connector indicates lack of the fuel of the vehicle, the control information generation program 114 may determine the control information comprising at least one phone number 443 of the calls of the communication list, within a predetermined time from the fuel shortage signal reception point as shown in FIG. 4C. In so doing, the control information generation program 114 may determine the control information comprising at least one closest gas station phone number 444 based on the location information of the electronic device.

For example, when the signal received from the OBD connector indicates battery discharge of the vehicle, the control information generation program 114 may determine the control information by considering a phone number 463 of the schedule information as shown in FIG. 4D. In so doing, the control information generation program 114 may determine the control information comprising at least one closest garage phone number 464 by considering the location information of the electronic device.

For example, when the signal received from the OBD connector indicates the overheated engine of the vehicle, the control information generation program 114 may determine the control information comprising “Overheated engine can cause an accident so we stop the car. Please calm down and make a call” 481 as shown in FIG. 4E.

The application program 115 can include at least one software component for at least one application program installed in the electronic device 100.

The processor unit 120 can include a memory interface 121, at least one processor 122, and a peripheral interface 124. Herein, the memory interface 121, the at least one processor 122, and the peripheral interface 124 of the processor unit 120 can be integrated onto at least one integrated circuit or implemented using separate components.

The memory interface 121 controls the access of the component such as processor 122 or peripheral interface 124, to the memory 110.

The peripheral interface 124 controls connection between an input/output peripheral of the electronic device 100 and the processor 122 and the memory interface 121.

The processor 122 controls the electronic device 100 to provide various multimedia services using at least one software program. In so doing, the processor 122 executes at least one program stored in the memory 110 and provides the service according to the corresponding program.

The audio processor 130 provides an audio interface between the user and the electronic device 100 through a speaker 131 and a microphone 132.

The communication system 140 can process voice communication and data communication. The communication system 140 can be divided into a plurality of communication submodules which support different communication networks. For example, the communication networks include, but not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, and a Near Field Communication (NFC) network.

The input/output controller 150 provides an interface between the input/output device such as display 160 and input device 170, and the peripheral interface 124.

The display 160 displays the status information of the electronic device 100, a character input by the user, a moving picture, and a still picture. For example, the display 160 displays application information driven by the processor 122. For example, under the control of the GUI program 113, the display 160 displays the control information generated by the control information generation program 114 in the topmost layer of at least one layer displayed by the display 160.

The input device 170 provides input data generated by a user's selection to the processor unit 120 via the input/output controller 150. In so doing, the input device 170 can include a keypad including at least one hardware button, and a touchpad for detecting touch information. For example, the input device 170 provides the touch information detected by the touchpad to the processor 122 via the input/output controller 150.

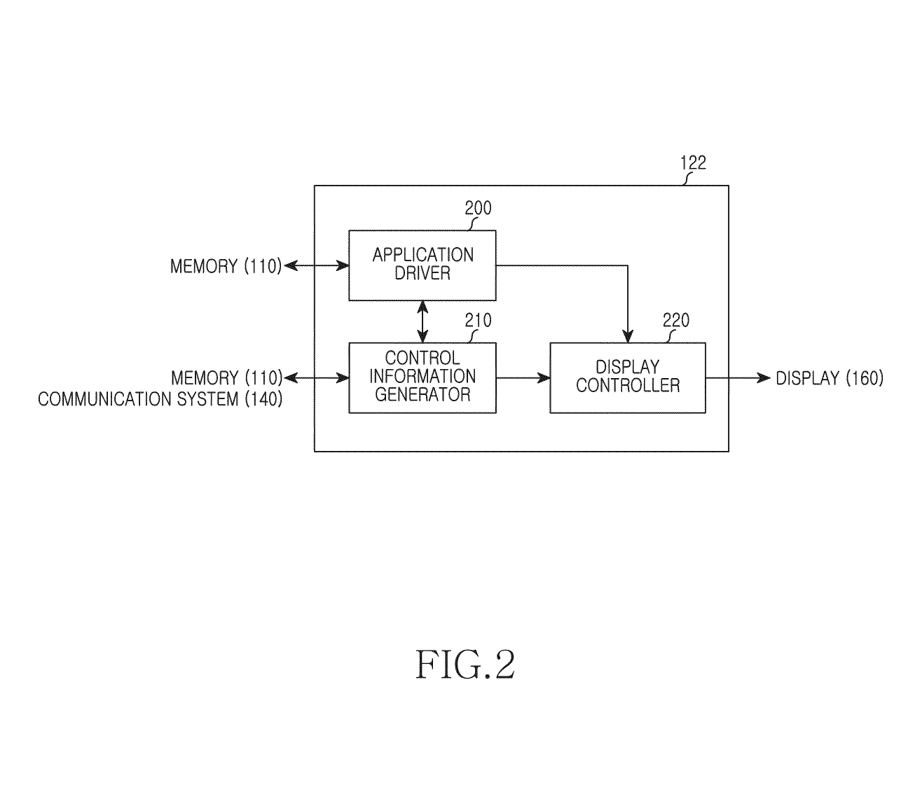

FIG. 2 is a detailed block diagram of the processor according to an embodiment of the present disclosure.

As shown in FIG. 2, the processor 122 can include an application driver 200, a control information generator 210, and a display controller 220.

The application driver 200 executes at least one application program 115 stored in the memory 110 and provides the service according to the corresponding program. For example, the application driver 200 controls the control information generator 210 to drive at least one application program.

The control information generator 210 controls the control information generation program 114 stored in the program storage 111 to generate the control information corresponding to the status information of the other electronic device using the signal received from the other electronic device via communication system 140 and stored in memory 110. Herein, the control information can include at least one of the contact information, the application program, and the status guide message. The control information can include at least one of the data stored in the electronic device and the data provided from the server. For example, when the signal received from the OBD connector indicates the vehicle was in an accident, the control information generator 210 determines the control information comprising at least one phone number 403 of the calls of the communication list, within the predetermined time from the accident signal reception point as shown in FIG. 4A. In so doing, the control information generator 210 may determine the control information comprising at least one phone numbers 403 by considering the call time order based on the accident signal reception point. The control information generator 210 may determine the control information comprising at least one phone number of the calls of the communication list over the predetermined count within the predetermined time from the accident signal reception point.

For example, when the signal received from the OBD connector indicates the vehicle accident, the control information generator 210 may determine the control information comprising at least one closest hospital phone number 423, by considering location information of the electronic device as shown in FIG. 4B.

For example, when the signal received from the OBD connector indicates the vehicle accident, the control information generator 210 may determine the control information comprising the shortcut of the camera application 401 as shown in FIG. 4A.

For example, when the signal received from the OBD connector indicates the lack of the fuel of the vehicle, the control information generator 210 may determine the control information comprising at least one phone number 443 of the calls of the communication list, within the predetermined time from the fuel shortage signal reception point as shown in FIG. 4C. In so doing, the control information generator 210 may determine the control information comprising at least one closest gas station phone number 444 by considering the location information of the electronic device.

For example, when the signal received from the OBD connector indicates the battery discharge of the vehicle, the control information generator 210 may determine the control information by considering the phone number 463 of the schedule information as shown in FIG. 4D. In so doing, the control information generator 210 may determine the control information comprising at least one closest garage phone number 464 by considering the location information of the electronic device.

For example, when the signal received from the OBD connector indicates the overheated engine of the vehicle, the control information generator 210 may determine the control information comprising “Overheated engine can cause an accident so we stop the car. Please calm down and make a call” 481 as shown in FIG. 4E.

The display controller 220 controls the GUI program 113 stored in the program storage 111 to display the graphical user interface on the display 160. For example, the display controller 220 controls to display the control information generated by the control information generator 210 in the topmost layer of at least one layer displayed by the display 160.

As such, the electronic device 100 controls to generate the control information using the processor 122 including the control information generator 210.

Alternatively, the electronic device 100 may include a separate control information generation module for generating the control information.

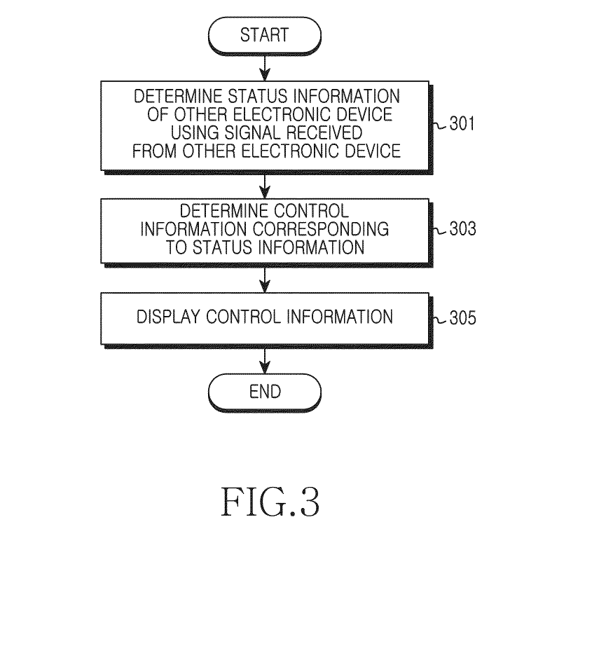

FIG. 3 depicts a method for generating the control information corresponding to the status information of the other electronic device, in the electronic device according to an embodiment of the present disclosure.

Referring to FIG. 3, the electronic device checks the status information of the other electronic device using the signal received from the other electronic device in operation 301.

For example, the electronic device can receive the status information of the vehicle from the OBD connector of the vehicle using short-range wireless communication (e.g., wireless LAN, Wi-Fi Direct, Bluetooth, NFC, and Zigbee). The electronic device may receive the status information of the vehicle from a separate server. In this case, the status information of the vehicle is assumed to be provided by the server through the OBD connector.

For example, the electronic device may receive the status information of the house from a home automation (security, gas leak detection, and fire detection) system of the house via a communication system (e.g., GSM network, EDGE network, CDMA network, W-CDMA network, LTE network, and OFDMA network). A security sensor, a gas leak sensor, and a fire sensor installed in the house can send and receive data using the wireless LAN communication or wired communication.

In operation 303, the electronic device determines the control information corresponding to the status information. Herein, the control information can include at least one of the contact information, the application program, and the status guide message. The control information can include at least one of the data stored in the electronic device and the data provided from the server.

For example, when the signal received from the OBD connector indicates the vehicle was in an accident, the electronic device determines the control information comprising at least one phone number 403 of the calls of the communication list within the predetermined time from the accident signal reception point as shown in FIG. 4A. That is, when detecting an impact over a threshold level from a shock sensor of the vehicle, the OBD connector of the vehicle recognizes the vehicle was in an accident and transmits the status information of the vehicle to the electronic device. In so doing, the electronic device may determine the control information comprising at least one phone numbers 403 by considering the call time order based on the accident signal reception point. The electronic device may determine the control information comprising at least one phone number of the calls of the communication list over the predetermined count within the predetermined time from the accident signal reception point.

For example, when the signal received from the OBD connector indicates the vehicle accident, the electronic device may determine the control information comprising at least one closest hospital phone number 423, by considering the location information of the electronic device as shown in FIG. 4B.

For example, when the signal received from the OBD connector indicates the vehicle accident, the electronic device may determine the control information comprising the shortcut of the camera application 401 as shown in FIG. 4A.

For example, when the signal received from the OBD connector indicates the lack of the fuel of the vehicle, the electronic device may determine the control information comprising at least one phone number 443 of the calls of the communication list within the predetermined time from the fuel shortage signal reception point as shown in FIG. 4C. That is, when detecting the fuel below a threshold level from a fuel sensor of the vehicle, the OBD connector of the vehicle recognizes that the vehicle needs to refuel and thus transmits the status information of the vehicle to the electronic device. In so doing, the electronic device may determine the control information comprising at least one closest gas station phone number 444 by considering the location information of the electronic device.

For example, when the signal received from the OBD connector indicates the battery discharge of the vehicle, the electronic device may determine the control information by considering the phone number 463 of the schedule information as shown in FIG. 4D. That is, when detecting the battery capacity below a predetermined level from a battery capacity sensor of the vehicle, the OBD connector of the vehicle recognizes that the vehicle needs to recharge and thus transmits the status information of the vehicle to the electronic device. In so doing, the electronic device may determine the control information comprising at least one closest garage phone number 464 by considering the location information of the electronic device.

For example, when the signal received from the OBD connector indicates the overheated engine of the vehicle, the electronic device may determine the control information comprising “Overheated engine can cause an accident so we stop the car. Please calm down and make a call” 481 as shown in FIG. 4E. That is, when detecting the engine temperature over a predetermined temperature from an engine temperature sensor of the vehicle, the OBD connector of the vehicle recognizes that the vehicle needs to pull over and thus transmits the status information of the vehicle to the electronic device.

In operation 305, the electronic device displays the control information. For example, the electronic device displays at least one control information in the topmost layer of at least one layer displayed by the display 160.

Next, the electronic device finishes this process.

In addition, when the control information displayed in operation 305 is selected, the electronic device can make a call to at least one phone number, send an Short Messaging Service (SMS) message, and drive at least one application program. When the control information displayed in operation 305 is not selected, the electronic device may make a call to at least one phone number, send the SMS message, and drive at least one application program after a predetermined time starting from the control information display.

As set forth above, the electronic device generates the control information corresponding to the status information of the other electronic device using the signal received from the other electronic device, and thus an electronic device user can easily handle the status information of the other electronic device based on the control information.

It will be appreciated that various embodiments of the present according to the claims and description in the specification can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
checking status information of another electronic device using a signal received from the other electronic device;
determining control information corresponding to the status information; and
displaying the control information.

2. The method of claim 1, wherein the control information comprises at least one of contact information, an application program, and a status guide message.

3. The method of claim 1, wherein the determining of the control information comprises:
determining the control information comprising at least one phone number from a communication list of the electronic device.

4. The method of claim 3, wherein the determining of the control information comprising the at least one phone number comprises:
determining the control information comprising at least one phone number based on a call time order based on the signal reception in the electronic device.

5. The method of claim 1, wherein the determining of the control information comprises:
determining the control information by considering location information of the electronic device.

6. The method of claim 1, wherein the determining of the control information comprises:
determining the control information by considering a phone number of schedule information of the electronic device.

7. The method of claim 1, wherein the determining of the control information comprises:
determining the control information comprising at least one application program corresponding to the status information from a plurality of application programs of the electronic device.

8. The method of claim 1, wherein the determining of the control information comprises:
determining the control information comprising at least one status guide message corresponding to the status information.

9. The method of claim 1, wherein the displaying of the control information comprises:
displaying the control information in a topmost layer of at least one layer displayed by a display of the electronic device.

10. An electronic device comprising:
a display;
at least one processor;
at least one memory; and
at least one program stored in a memory and executed by the at least one processor,
wherein the processor checks status information of other electronic device using a signal received from the other electronic device, determines control information corresponding to the status information, and displays the control information.

11. The electronic device of claim 10, wherein the control information comprises at least one of contact information, an application program, and a status guide message.

12. The electronic device of claim 10, wherein the processor determines the control information comprising at least one phone number from a communication list of the electronic device.

13. The electronic device of claim 10, wherein the processor determines the control information comprising at least one phone number based on a call time order based on the signal reception in the electronic device.

14. The electronic device of claim 10, wherein the processor determines the control information by considering location information of the electronic device.

15. The electronic device of claim 10, wherein the processor determines the control information by considering a phone number of schedule information of the electronic device.

16. The electronic device of claim 10, wherein the processor determines the control information comprising at least one application program corresponding to the status information from a plurality of application programs of the electronic device.

17. The electronic device of claim 10, wherein the processor determines the control information comprising at least one status guide message corresponding to the status information.

18. The electronic device of claim 10, wherein the display displays the control information in a topmost layer of at least one layer displayed by a display of the electronic device.
